(19) United States
(12) Patent Application Publication
(10) Pub. No.: US 2026/0290720 A1
(43) Pub. Date: Sep. 24, 2026

(54) SNAP-ACTION SWITCH

(71) Applicant: Schaltbau GmbH, München (DE)

(72) Inventors: Grete Hofmann, München (DE); Denis Kemmer, München (DE); Armin Birnkammer, Vilsbiburg (DE)

(21) Appl. No.: 19/100,022

(22) PCT Filed: Aug. 2, 2023
(86) PCT No.: PCT/EP2023/071392

§ 371 Date: Jan. 30, 2025

(30) Foreign Application Priority Data
Aug. 8, 2022 (DE) 10 2022 119 929.0

(51) Int. Cl. H01H 13/26; H01H 13/20

(52) U.S. Cl. CPC H01H 13/26; H01H 13/20

(57) ABSTRACT

A two-conductor field device, comprising a measuring transducer for capturing a measurement variable, an electronic unit for processing the measurement data and a two-conductor interface for supplying power to the two-conductor field device and for communicating with a superordinate unit, characterized in that the two-conductor field device has a display unit for signaling a state of the two-conductor field device, which display unit can be visually read remotely.

### CROSS REFERENCE TO RELATED APPLICATIONS

This patent application claims priority to PCT Patent Application PCT/EP2023/071392, filed on Aug. 2, 2023, and thence to German Patent Application 102022119929.0 filed on Aug. 8, 2022.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The invention is a snap-action switch.

### BACKGROUND OF THE INVENTION

Snap-action switches are basically known from prior art and usually comprise a housing, a contact bridge with two switch positions that can be switched via an actuation plunger for the electrical connection of fixed contacts, in particular, at least one first contact pair in the first switch position and at least one second contact pair in the second switch position. Two snap-action springs are supported substantially symmetrically and in a pretensioned manner on one actuation element and the actuation plunger, and which have pitch lines can be shifted by the actuation element in such a way that the actuation plunger can be snapped over from the first switch position, in which the actuation plunger is substantially in the resting position, into the second switch position, in which the actuation plunger is substantially in the actuation position.

Snap-action switches have in common that they work with a bistable snap-on spring assembly which results in a rapid switching movement when a certain switching point is exceeded. This fast switching movement is intended to minimize flashover and thus damage to the contact elements. In order to provide this feature, it does not matter whether the spring arms are designed as a single piece with the contact bridge or as separate components.

A snap-action switch known from prior art is shown in FIG. 9.

The snap-action switch shown comprises a rectangular housing 1 in its cross-section, which is used to accommodate the individual components of the snap-action switch. In the centre of housing 1, there is an actuation plunger 2, which comprises a stop notch inside housing 1 that rests on an inner side of a wall of housing 1 in the resting position of the actuation plunger 2. The actuation plunger 2 is pushed upwards into its resting position by a compression spring 4 so that the stop notch 3 reliably comes to rest. The actuation plunger 2 is guided in a sleeve-like receptacle in the area of the compression spring 4 and at an end opposite the compression spring 4 in a recess of the housing 1.

Approximately at the height of half of a longitudinal extension of the actuation plunger 2 located within the housing 1, it comprises two diametrically shaped receptacle notches 7, i.e., in the present exemplary embodiment, opposite each other in a mirror-inversed manner, each of which is designed for the single-sided support of a snap-action spring 8, 9 bent in a V-shaped manner. Via the snap-action springs 8, 9, a contact support 10 is held on the actuation plunger 2 in a pretensioned manner.

The other end of the snap-action springs 8, 9 is respectively held in a notch U, 12 of an isolating spacer 13, 14. The spacers 13, 14 keep an upper contact arm 15 and a lower contact arm 16 aligned parallel to one another and keep them spaced away from one another. The contact arms 15, 16 are about O-shaped as viewed from the top. The holding occurs by placing the snap-action springs 8, 9 in a pretensioned manner between the actuation plunger 2 and the spacers 13, 14 so that the spacers 13, 14 are pressed against the contact arms 15, 16 and thus fix them into position.

The contact arms 15, 16 comprise contact regions 17, 18, 19, 20 arranged on the end side, wherein the contact regions 17, 18, 19, 20 arranged on the contact arms 15, 16 are assigned fixed contacts 21, 22, 23, 24 arranged opposite each other so that one contact arm 15, 16 in the actuation position and the other contact arm 16, 15 in the resting position of the snap-action switch each contact the fixed contacts 21, 22, 23, 24 respectively assigned to it and electrically connects it to each other.

A first fixed contact 21 is assigned to a first contact region 17 and a second fixed contact 22 is assigned to a second contact region 18. The first fixed contact 21 and the second fixed contact 22 can thus be electrically connected to each other via the upper contact bridge 15 and form a first contact pair. Analogously, a third fixed contact 23 is assigned to a third contact region 19 and a fourth fixed contact 24 is assigned to a fourth contact region 20 so that the third fixed contact 23 and the fourth fixed contact 24 can be electrically connected to one another via the lower contact bridge 16 and form a second contact pair.

Since such snap-action switches can lead to an undesirable welding of the contact regions of the contact arms with the contacts of the contact pairs, i.e., the fixed contacts, lever elements for forced opening are provided in some applications. In Annex K, the DIN EN 60947-5-1 standard prescribes such a rigid, positive-locking forced opening for snap-action switches in accordance with the standard spring mechanism in addition to the snap-on spring mechanism so that, for safety reasons, the normally-closed-contact position is reliably opened when the actuation element of the snap-action switch is actuated. This forced opening is able to open contact parts welded by overcurrent by applying the appropriate force. These lever elements can usually be swivelled over the actuation plunger and can be attached to the contact support or the contact arms with one end and, if sufficient force is applied to the actuation plunger, lead to pressing of the contact regions by the contact pairs and thus to a forced opening of the switch position. In order to carry out one of the switch positions as a resting position, an additional spring element can be integrated in the snap-action switch in such a way that the position of the contact support in the idle position is stabilized by the force of the spring element, as in the example shown in FIG. 9.

The well-known snap-action switches are already very reliable and can be used for safety-critical applications. However, it is perceived as a disadvantage that these can fail electrically due to different effects, i.e., that a conductive connection between the fixed contacts is not or only insufficiently established by the contact arms. Reasons for such a failure can include excessive contact resistances due to deposits of contamination or burn-up on the contacts, breakages of the snap-action springs or the contact bridge due to mechanical and/or thermal loads.

It is therefore the task of the present invention to improve a known snap-action switch.

This problem is solved, with favorable further embodiements, by a snap-action switch with the features as described herein.

### BRIEF SUMMARY OF THE INVENTION

In a preferred embodiment, a snap-action switch (100) comprising a housing (1), an actuation plunger (2) with two switch positions with at least one contact bridge (31, 32) for electrically connecting at least one first contact pair (23, 24) in a switch position and with snap-on springs (8, 9) supporting themselves substantially symmetrically and in a pretensioned manner on an actuation element (3) and the actuation plunger (2), the pitch lines of which can be shifted by the actuation element (3) in such a way, that the actuation plunger (2) can be snapped from a first switch position, in which the actuation plunger (2) is substantially in the resting position, to a second switch position, in which the actuation plunger (2) is substantially in the actuation position, wherein the snap-action switch (100) also comprises a forced-opening assembly with which it is switching at least from the first to the second switch position is imposed on the actuation element (3) when a forced-opening force is exceeded, characterized in that the at least one contact bridge (31, 32) on one end and on the other hand has at least two respective contact points (17, 18, 19, 20) for electrically parallel contacting of the first contact pair (23, 24), wherein each of the contact points (17, 18, 19, 20) is designed in such a way as to entirely switch an electrical rated power of the snap-action switch (100).

In another preferred embodiment, the snap-action switch (100) as described herein, characterized in that the snap-action switch comprises two contact bridges (31, 32) for electrically connecting at least the first contact pair (23, 24) and at least one second contact pair (21, 22), wherein the contact points of the second contact bridge are also designed in such a way as to entirely switch an electrical rated power of the snap-action switch (100).

In another preferred embodiment, the snap-action switch (100) as described herein, characterized in that, in the first switch position, the first contact pair and in the second switch position the second contact pair (21, 22) is connected.

In another preferred embodiment, the snap snap-action switch (100) as described herein, characterized in that the contact bridges (31, 32) are each designed as a single piece.

In another preferred embodiment, the snap snap-action switch (100) as described herein, characterized in that the contact bridges (31, 32) are designed in the form of a double H-bridge, each with two bridge limbs (311, 312) on either side of the actuation plunger (2) and at least one transverse bar (313).

In another preferred embodiment, the snap snap-action switch (100) as described herein, characterized in that the contact bridges (31, 32) are designed in such a way that, on both sides of the actuation plunger (2), one bridge limb (311) is formed to be leading, and the other bridge limb (312) is designed to be trailing behind.

In another preferred embodiment, the snap snap-action switch (100) as described herein, characterized in that the contact bridges (31, 32) are spring-elastic.

In another preferred embodiment, the snap snap-action switch (100) as described herein, characterized in that the contact bridges (31, 32) are designed in such a way and the contact points (17, 18, 19, 20) are arranged in such a way and are arranged relative to the contact pairs (21, 22, 23, 24) that the contacts are self-cleaning.

In another preferred embodiment, the snap snap-action switch (100) as described herein, characterized in that the contact points (17, 18, 19, 20) and the contact pairs are formed and arranged relative to each other in such a way that, at least when the contacts are closed, a lateral movement is caused between the contact point (17, 18, 19, 20) and the contact pair.

In another preferred embodiment, the snap snap-action switch (100) as described herein, characterized in that the at least two contact bridges (31, 32) are each assigned a reinforcement assembly in the direction of opening.

In another preferred embodiment, the snap snap-action switch (100) as described herein, characterized in that the reinforcement assembly (25, 26) is located on the actuation plunger (2).

In another preferred embodiment, the snap snap-action switch (100) as described herein, characterized in that the reinforcement assembly is desigend as a single piece with the actuation plunger (2).

In another preferred embodiment, the snap snap-action switch (100) as described herein, characterized in that the reinforcement assembly is designed as a formation extending from the actuation plunger (2) in the direction of an extension direction of the contact bridge (31, 32), in particular, in the form of reinforcement arms (25, 26).

In another preferred embodiment, the snap snap-action switch (100) as described herein, characterized in that the formations support the bend limbs at least to ⅕, preferably at least to ¼, more preferably at least to half, being particularly preferred, to ¾.

In another preferred embodiment, the snap snap-action switch (100) as described herein characterized in that the formations are designed in such a way that the contact bridges are pretensioned.

In another preferred embodiment, the snap snap-action switch (100) as described herein, characterized in that the formations are dimensioned in such a way that an opening force of at least 10 N, preferably at least 20 N, and furthermore preferably at least 30 N can be transferred to the bridge limbs (311, 312).

### BRIEF DESCRIPTION OF THE DRAWINGS

FIG. 1 is a line drawing showing a first exemplary embodiment of a snap-action switch in accordance with the present application in a simplified illustration,

FIG. 2 is a line drawing showing a principal sketch of the actuation plunger with the first contact bridge and assigned fixed contacts,

FIGS. 3A to 3C are line drawings showing a closing process of a contact bridge of the snap-action switch in accordance with FIG. 2,

FIGS. 4A to 4C are line drawings showing an opening process of the contact bridge from FIG. 3,

FIGS. 5A and 5B are line drawings showing an alternative embodiment of a contact bridge when closing (FIG. 5A)) and opening (FIG. 5B)),

FIG. 6 is a line drawing showing a third embodiment of a contact bridge,

FIG. 7 is a line drawing showing a fourth embodiment of a contact bridge,

FIGS. 8A and 8B are line drawings showing a contact bridge with a leading and a trailing bridge limb and

FIG. 9 is a line drawing showing a snap-action switch in accordance with prior art (already discussed).

### DETAILED DESCRIPTION OF THE INVENTION

A snap-action switch according to the invention comprises a housing, an actuation plunger comprising two switch positions with at least one contact bridge for the electrical connection of at least one first contact pair in a switch position, and with snap-action springs supporting themselves substantially symmetrically and in a pretensioned manner on an actuation element and the actuation plunger and which have pitch lines that can be shifted by the actuation element in such a way that the actuation plunger can be snapped from a first switch position, in which the actuation plunger is substantially in the resting position, into a second switch position, in which the actuation plunger is substantially in the actuation position, wherein the snap-action switch also comprises a forced-opening assembly with which a switching at least from the first into the second switch position is imposed on the actuation element when a forced-opening force is exceeded, wherein the at least one contact bridge has at least two respective contact points at one and the other end for the electrically parallel contacting of the first contact pair, wherein each of the contact points is designed in such a way as to entirely switch an electrical rated power of the snap-action switch.

The embodiment according to the invention creates an electrical and mechanical redundancy so that, even in the event of a failure of up to two contact points, the snap-action switch continues to be available. The contact bridge can be implemented by means of electrically and mechanically parallel electrical conductors, wherein, in this way, for example, in the case of two parallel electrical conductors, the electrical or mechanical failure of one of the conductors, i.e., in this case, the two contact points assigned to this conductor, can be compensated for.

The snap-action switch can be designed as a normally closed contact or as a normally open contact, wherein the resting position of the actuation plunger defines whether it is a normally closed contact, i.e., a N.C. contact or as a normally open contact, thus a N.O. contact.

In a favourable embodiment, the snap-action switch comprises two contact bridges for the electrical connection of at least the first contact pair and at least one second contact pair, wherein the contact points of the second contact bridge are also designed in such a way that the electrical rated power of the snap-action switch is entirely switched.

Two contact bridges can be used to create a double-pole N.C. contact or a double-pole N.O. contact.

If the snap-action switch is designed in such a way that the first contact pair is connected in the first switch position and the second contact pair in the second switch position, then the snap-action switch is a normally closed or a normally open contact, depending on which fixed contacts are contacted from the outside.

In an favourable embodiment, the snap-action switch comprises a housing, an actuation plunger comprising two switch positions with at least two contact bridges for the electrical connection of at least one first contact pair in the first switch position and at least a second contact pair in the second switch position, and with snap-action springs that are supported substantially symmetrically by a actuation element and the actuation plunger and in a pretensioned manner, the pitch lines of which are the actuation element can be shifted in such a way that the switching plunger can be snapped from the first switch position, in which the actuation plunger is substantially in the resting position, to the second switch position, in which the actuation plunger is substantially in the actuation position, wherein the snap-action switch also comprises a forced-opening assembly with which a switching from the first to the second switch position is imposed on the actuation element when a forced-opening force is exceeded, characterized in that the at least two contact bridges respectively have at least two contact points on the one end and on the other end for the electrically parallel contacting of the first contact pair in the first switch position and of the second contact pair in the second switch position, wherein each of the contact points is designed in such a way as to entirely switch an electrical rated power of the snap-action switch.

An embodiment of the contact bridges with at least two contact points respectively has the advantage that in this way an electrically parallel contact of the contact pairs can take place. This means that the failure of one switching point per contact part can be compensated for per switching bridge, which means that both at one end of the contact bridge as well as at the other end of the contact bridge, one contact part, for example, can fail due to dirt, burn-up or a mechanical defect, and the functionality of the snap-action switch is still retained. This creates additional redundancy and increases switching reliability. The availability of the snap-action switch is increasing.

In the case of an embodiment with two contact points respectively per bridge end, the following contact options may be available if the parts of the contact bridge are cross-contacted, i.e., if the contact bridge is designed in such a way that all contact points are electrically connected to each other: Ideally, both contact points on both sides should be contacted. In the event of a failure of one of the contact points either on the inlet side and/or on the outlet side, a constellation is given that at least one contact point is functional in each case.

In the present case, the term “contact point” only serves to distinguish between the different positions of the contacts. Contact points are therefore not necessarily designed in the form of points but can also be linear or flat.

The term contact pair is also only used to distinguish between them. Contact pairs are always the contact points of the assigned fixed contacts arranged at opposite ends of a switching bridge. These comprise at least two contact points, i.e., a pair, but can also comprise a plurality of contact parts. Preferably, however, the fixed contacts at both ends of the contact bridge comprise an identical number of contact points.

In an favourable further embodiment of the snap-action switch, the contact bridges are each designed as a single piece. In this context, single piece means that the contact bridges are made of the same material throughout, which has both the energy transfer as well as the static load-bearing properties. In contrast to prior art, the contact bridges are characterized by a simple design. The material of the contact bridges is preferably designed to be both conductive as well as load-bearing for this purpose.

A metal or metal alloy with springy properties is particularly suitable for the embodiment of the contact bridge. For example, a spring steel can be used, wherein bronze, brass, nickel silver or copper alloys are preferred due to their higher conductivity. A copper-beryllium alloy is particularly preferred, as it combines particularly good electrical and thermal conductivity and mechanical properties. Copper-nickel-silicon alloys can also be used due to the good electrical and thermal conductivity that can be achieved with these alloys in combination with good mechanical properties. Such an embodiment ensures that the contact bridge is still mechanically stable and sufficiently dimensioned for the currents to be switched with a small material cross-section.

In a preferred embodiment, the contact bridges are designed in the form of a double H-bridge, each with an H-bridge with two bridge limbs on each side of the actuation plunger and at least one transverse bar.

The term H-bridge refers to the design of the contact bridge in the shape of an “H”. This design provides two parallel contact paths for contacting the contact pairs of the fixed contacts, wherein, simultaneously, a transverse contact can be made from one limb of the H-bridge to the other limb of the H-bridge via the transverse bar.

The embodiment as an H-bridge also offers the advantage that the individual limbs of the H-bridge can be flexibly designed in the direction of operation so that height compensation of the individual contact points at one bridge end is possible. For example, the H-bridge can be used to a difference in height due to a particle between the contact parts at one end of the H-bridge.

The contact bridge may also be designed in such a way that, on both sides of the actuation plunger, one bridge limb is leading, and the other bridge limb is trailing behind. With such an embodiment, a contact bridge can be implemented in which mainly the contact point located on the leading bridge limb is loaded with switching arcs and the associated burn-up.

In this context, “leading” means that the leading limb of the switching bridge, or the contact point located on the leading limb, first comes into contact with the fixed contacts in the closing direction of the contact bridge and establishes an electrically conductive connection. The trailing contact point does not contact the fixed contact until there is already a conductive connection via the leading limb.

Conversely, when opening, this means that the trailing limb of the contact bridge first disconnects the electrical connection and only then opens the leading limb. This ensures that a switching arc occurs exclusively at the leading contact point and also that only the leading contact point tends to weld to the fixed contact, since the latter switches higher currents compared to the trailing contact.

Thus, the material of the respective contact point can be adapted to this in a preferred embodiment. In particular, the contact points on the leading limbs can be made more resistant to burn-up. Suitable materials for the contact points of the leading limb are, for example, silver, gold or silver or gold alloys.

Conversely, the trailing limb can have contact points made of a highly conductive but less resistant material, for example, gold.

With mixed loads, the advance contact point switches the high currents and is loaded accordingly. The trailing contact point switches when a contact resistance of the leading contact point becomes too great at lower currents. The trailing contact may comprise a contact material more suitable for lower loads because it does not switch high loads.

In another embodiment, the contact bridges are spring-elastic. This allows manufacturing tolerances to be compensated, and reliable contacting, for example, can be achieved by height compensation for particles. In addition, a spring-elastic embodiment of the contact bridges can support an opening of the snap-action switch. The metals and metal alloys already mentioned above for the embodiment of the contact bridge are particularly suitable as materials.

Reliable contacting can also be achieved if the contact bridges are designed in such a way and the contact points are arranged in such a way and relative to the contact pairs that the contacts are self-cleaning.

Self-cleaning of the contacts can, for example, can be achieved in that the contact points and the contact pairs are formed and arranged relative to each other in such a way that a lateral movement between the contact point and the contact pair is caused, at least when the contacts are closed.

Such a lateral movement, for example, deposits caused by burn-up are removed and cleared away in the course of lateral movement, which always ensures reliable contacting.

If, for example, the contact bridge is made of a spring-elastic material, so if there is already an electrical connection, i.e., if the contact points are already in contact with the contact pairs, a further movement of the contact bridge in the closing direction can cause a lateral movement of the contact points and the contact pairs relative to each other, wherein deposits are rubbed off and simultaneously pushed off the contacts.

In one embodiment, the at least two contact bridges may each be assigned a reinforcement assembly in the direction of opening. The reinforcement assembly can be used to ensure that the contact bridges themselves can be dimensioned weaker and still have sufficient stability. Such a reinforcement assembly can be particularly useful in the opening direction, as welds caused by thermal loads may have to be detached in this direction. Simultaneously, if a reinforcement assembly is only in the opening direction, there is flexibility in the closing direction on the one hand, and sufficient stability in the opening direction is ensured on the other hand.

Such a reinforcement assembly can, for example, be arranged on the actuation plunger, in particular, as a single piece with the actuation plunger.

Alternatively, a multi-part embodiment is also conceivable, in which the reinforcement assembly is designed as a separate component.

By arranging the reinforcement assembly, and in particular, by designing the reinforcement assembly as a single piece with the actuation plunger, a particularly space-saving and, in particular, easy implementation can be achieved in terms of production technology.

The reinforcement assembly can be, for example, as a formation extending from the actuation plunger in the direction of an extension direction of the contact bridge, in particular, in the form of reinforcing arms. Such formations can be used during the production of the actuation plunger, for example, can be implemented particularly easily in plastic injection formation and created in the necessary dimensions.

It is preferred that the formations support the bridge limbs at least to ⅕, preferably at least to ¼, more preferably at least half, being particularly preferred, at least to ¾ in the area projecting beyond the actuation plunger, at least in the uncontacted state. The larger the support area of the limbs of the contact bridge on the formations, the greater the support effect in the opening direction so that a support of more than ¾ can also be practical. The increased support effect is achieved by reducing an supernatant, i.e., the length that the contact bridge projects beyond the formation, due to a larger contact surface. An opening force acting on the actuation plunger is thus transferred to the contact bridge over a larger area and, simultaneously, a free projecting length of the contact bridge is reduced. A force acting against the opening, e.g., by welding the contact parts to the fixed contact acts via a reduced lever arm so that it is less needed to worry about buckling the contact bridge.

In a preferred embodiment, the formations are shaped in such a way that they pretension the contact bridge. An embodiment is therefore preferable in which the formations on the actuation plunger bend up a contour of the contact bridge so that it favourably has a defined preload.

Various benefits can be implemented by pretensioning the contact bridge. Manufacturing tolerances of the contact bridge can be compensated for without it having to be reworked, as the contact bridge is brought into a defined position by the formations. Furthermore, it is possible for the contact bridge to comprise a defined pretensioning and thus an increased force is immediately available in the opening direction to open the contacts.

In this context, the contour of the bridge limbs means in particular a course of the bridge limbs in a lateral view.

The contact bridge can be designed, in particular, as a stamped bent part. Stamped and bent parts can be produced cost-effectively in high quality.

Alternatively, other production methods can also be used, especially for smaller quantities. For example, different cutting methods, for example, by means of a water jet or laser with a subsequent bending step.

In order to be able to reliably transmit a prescribed opening force for forced opening of the resting position, the formations are dimensioned in such a way that an opening force of at least 10 N, preferably 20 N, and preferably 30 N can be transferred to the contact points of the bridge limbs. In this way, it can be ensured that the snap-action switches also comply with the DIN EN 60947-5-1 standard in accordance with the present application. However, the formations also make it possible to transmit higher forced-opening forces than the 20 N required by the standard so that a transmission of 30 N and more can be achieved.

The actuation plunger can, for example, be designed to be composed of at least two parts in such a way that the contact bridge between two parts of the actuation plunger can be inserted and thus fixed into position.

In an alternative embodiment, the contact bridge is overmolded with the actuation plunger. This embodiment has the advantage that it can be implemented particularly cost-effectively, reduces the number of components of the snap-action switch and offers a particularly good attachment of the contact bridge, as the contact bridge is fixed in the area of the actuation plunger in a positive-locking and non-positive-locking manner.

All contacts, both on the contact bridge as well as on the fixed contacts, can be cylindrical, flat or as a sphere/oval (contact rivet). In the case of ball contacts, the contact surface is point-shaped, in the case of cylindrical contacts it is linear, and in the case of two-sided contacts, it is flat.

The self-cleaning of the switching points can be designed to operate in a pushing or pulling manner. Depending on the angle at which the contact points and the contact pairs meet. a pushing or pulling relative movement is carried out between the contacts. Further details can be found in the exemplary embodiments described below.

Favourable embodiments and variants of the invention result from the subclaims and the following description. The features listed individually in the subclaims can be combined in any technically reasonable manner with each other as well as with the features explained in more detail in the following description and can represent other favourable embodiment variants of the invention.

### Detailed Description of the Figures

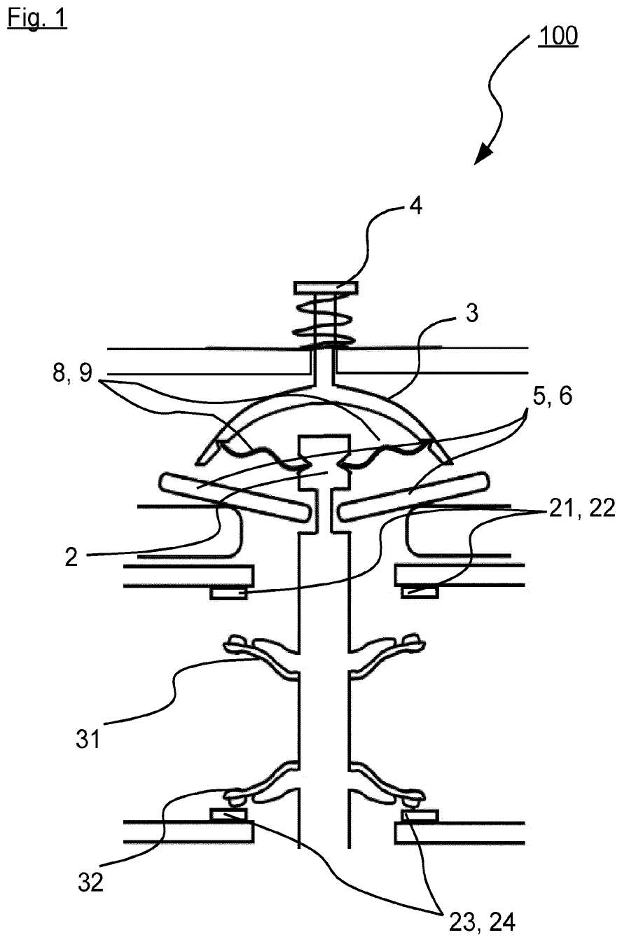

FIG. 1 shows a first exemplary embodiment of a snap-action switch 100 in accordance with the present application.

The snap-action switch 100 is simplified in the diagram shown and shown with the housing open so that the functionality of the components contained in the snap-action switch 100 is more clearly visible. The essential function of the snap-action switch 100 is carried out by an actuation plunger 2 comprising at least two switch positions, wherein the actuation plunger 2 can be switched by means of an actuation element 3 between a first switch position as shown in FIG. 1 and a second switch position in which the actuation plunger 2 is in a position shifted relative to the first switch position in the direction of the actuation element 3. The switching element 3 is connected to the actuation plunger 2 by means of two snap-action springs 8, 9 which support each other in parallel on the switching element 3 and the actuation plunger 2 so that the characteristic curves of the snap-action springs 8, 9 are shifted by the actuation of the actuation element 3 in such a way that the actuation plunger 2 is snapped from the first switch position to the second switch position. In the present exemplary embodiment, the actuation element 3 is also pressurized by means of a compression spring 4 so that the first switch position shown in FIG. 1 is stabilized by the compression spring 4.

The snap-action switch 100 shown in FIG. 1 also comprises a forced-opening assembly consisting of a first forced-opening lever 5 and a second forced-opening lever 6. The forced-opening levers 5, 6 are supported on the one hand by a circumferential collar of the actuation plunger 2 and, on the other end, they are mounted in the housing of the snap-action switch 100 in a shiftable manner. If a predetermined actuating force is applied via the actuation element 3, this comes to rest on the forced-opening levers 5, 6 and causes an indirect mechanical coupling of the actuation element 3 with the actuation plunger 2 via the forced-opening levers 5, 6 by tilting the forced-opening levers 5, 6 so that, in the event that a snapping of the actuation plunger 2 from the first switch position to the second switch position could not be effected, a mechanically forced switching takes place.

As already explained in relation to prior art, such a forced opening may be necessary if, for example, due to thermal loads, contacts of the snap-action switch 100 are welded together in a switch position (in this case the first switch position) and, as a result, the snap-action springs 8, 9 are not able to detach the contacts and switch the switch position.

In the case of the snap-action switch 100 shown in FIG. 1 in the present case, a first contact bridge 31 and a second contact bridge 32 are arranged on the actuation plunger 2, wherein, in the first switch position of the actuation plunger 2 shown in FIG. 1, the first contact bridge 31 is not in contact with fixed contacts 21, 22 assigned to it and the second contact bridge 32 electrically connects a third fixed contact 23 and a fourth fixed contact 24 with one another. For contacting the respective fixed contacts 21, 22, 23, 24, the contact bridges 31, 32 have contact points arranged on the end side of them, which strengthen the contact bridges and thus make them wear-resistant.

FIG. 2 shows a principle sketch of the actuation plunger 2 with the first contact bridge 31 and the fixed contacts 21, 22 assigned to it in the second switch position.

The following embodiments regarding the first contact bridge 10 31 also apply, mutatis mutandis, to the second contact bridge 32.

The illustration in FIG. 2 is greatly simplified and is substantially intended to explain the principle of action of the depicted embodiments in more detail. At the actuation plunger 2, the first contact bridge 31, which is now shown in detail, is recessed in the actuation plunger 2. The first contact bridge 31 is designed in the embodiment shown as a so-called H-bridge, wherein the contact bridge 31 resembles the letter “H” in a top view from above and comprises two parallel bridge limbs 311, 312, which are connected to each other by means of a transverse bar 313, which is not visible in FIG. 2. At the bridge limbs 311, 312, reinforced contact points 314, 315, 316, 317 are arranged at the end, which strengthen the contact bridge 31 and thus make it wear-resistant. In the present exemplary embodiment, the contact points 314-317 are designed as cylindrical shell-shaped reinforcement surfaces welded to the ends of the bridge limbs 311, 312. In the present exemplary embodiment, the cylindrical shape, which extends transversely to the direction of extension of the bridge limbs 311, 312, establishes a linear contact surface between the fixed contacts 21, 22 and the contact points 314-317, which are flat in the present embodiment, via which an electric current flows.

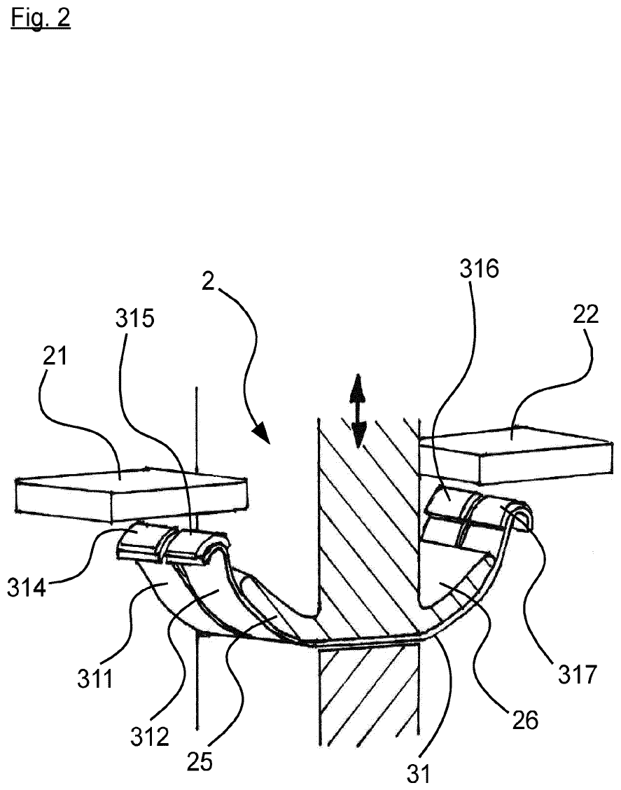

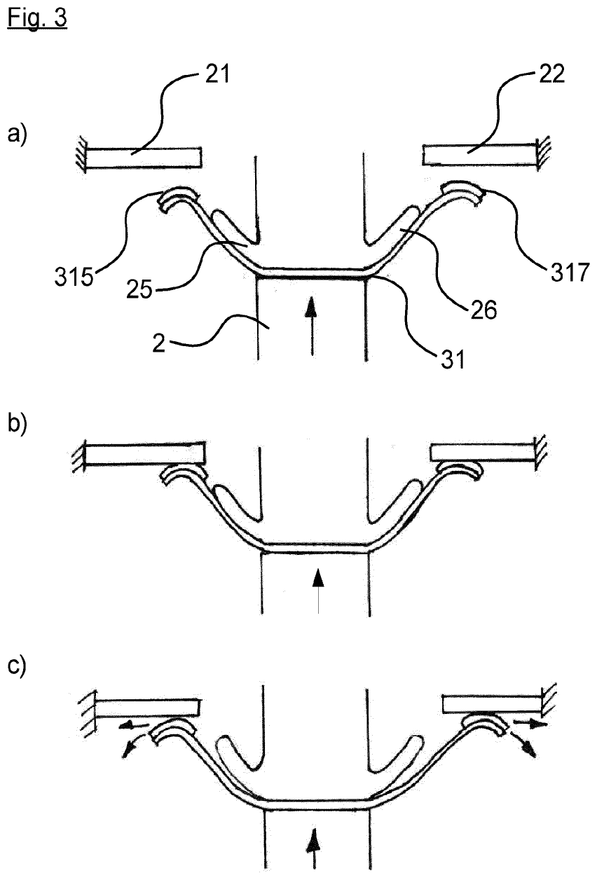

In contrast to the prior art, the contact bridge 31 is not designed in the form of a contact support, i.e., in particular, being stiffly rigid, but as a concave bent leaf spring, which, in the opening direction, i.e., when an electrical contact closed between the contact points 314-317 and the fixed contacts 21, 22 is reopened, by means of a reinforcement assembly in the form of reinforcement arms 25, 26 arranged on the actuation plunger 2. In the present exemplary embodiment, the reinforcing arms 25, 26 are formed as single-piece formations with the actuation plunger 2 and support the contact bridge 31 in the opening direction, as will be explained in more detail below in connection with FIG. 3.

FIG. 3 shows in sub-Figures 3a) to 3c) the assembly of FIG. 2 in a top view from the front when closing the contact between the contact bridge 31 and the fixed contacts 21, 22.

FIG. 3a) shows how the actuation plunger 2 moves from the first switch position, in which—as shown in FIG. 1—t he second contact bridge 32 contacts the fixed contacts 23, 24 to the second switch position, in which a contact is made between the first contact bridge 31 and the fixed contacts 21, 22. The direction of movement of the actuation plunger 2 is indicated by the arrow drawn in FIG. 3a). In the first part of the figure, it can be clearly seen that the bridge limbs 311, 312, which extend on both sides of the actuation plunger 2, in the present illustration this is the bridge limb 312 pointing forward, are attached to the reinforcement assembly in the form of reinforcement arms 25, 26. The first contact bridge 31 is shaped in such a way that the bridge limbs 311, 312 follow the contour of the reinforcing arms 25, 26 first with positive curvature and then turn with negative curvature in the direction of the horizontal fixed contacts 21, 22.

FIG. 3b) shows the time at which the contact points 315-317 of the contact bridge 31 come into contact with the fixed contacts 21, 22. In principle, a movement of the actuation plunger 2 could stop at this time, since at this time there is contact between the fixed contacts 21, 22 and the contact points 314-317 and thus an electrically conductive path is established between the first fixed contact 21 and the second fixed contact 22. However, in order to further increase the reliability of the snap-action switch in accordance with the present application, the contact parts formed by contact points 314-317 and fixed contacts 21, 22 are designed to be self-cleaning, i.e., particles, deposits or deposits caused by the burn-up of the materials on fixed contacts 21, 22 or contact points 314-317 are mechanically loosened and pushed away. In the present exemplary embodiment, this is done by moving the actuation plunger 2 in the direction shown from the situation shown in FIG. 3b), in which there is already contact between the contact points 314-317 and the fixed contacts 21, 22, wherein the spring-elastic contact bridge 31 is slightly bent, which causes a lateral movement between the fixed contacts 21, 22 and contact points 314-317. Through this lateral movement, the contact points 314-317 are guided along the fixed contacts 21, 22 so that deposits and particles are loosened by the friction generated on the contact parts and pushed outwards. In this way, a continuously low contact resistance between the contact points 314-317 and the fixed contacts 21, 22 is ensured and thus the reliability of the snap-action switch 100 is increased.

In addition, the contact bridges 31, 32, which are formed with individual bridge limbs 311, 312, ensure that in the event of deposits and particles on one of the contact partners, height compensation can take place due to the spring-elastic embodiment of the contact bridge—even between the individual limbs 311, 312 for contacting a fixed contact 21, 22—wherein an electrical contact is closed even more reliably.

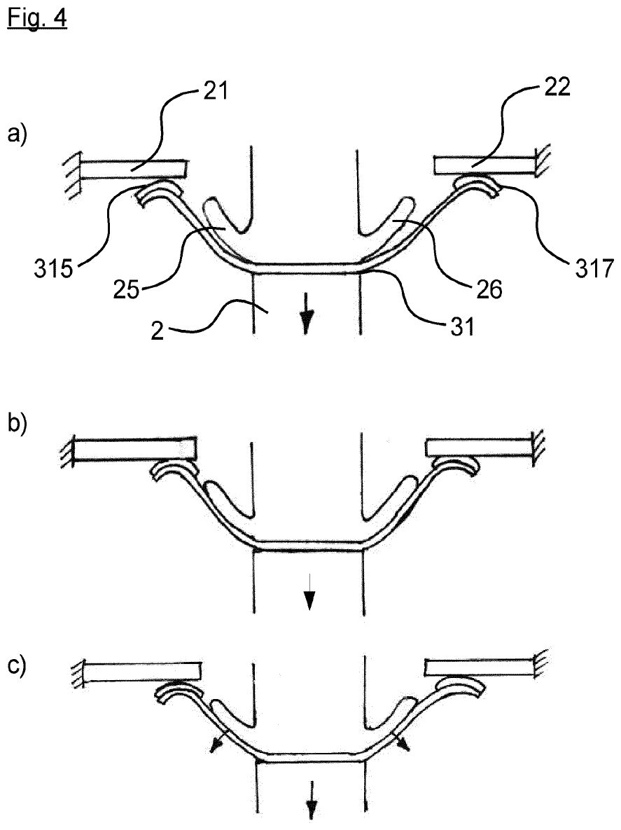

FIG. 4a) to c) show an opening process of the contact bridge 31 from FIG. 3.

FIG. 4a) shows the situation achieved in FIG. 3c) after the complete closure of the contact bridge 31 from FIG. 3. As indicated by the arrows drawn in FIG. 4a) to c), the actuation plunger 2 now moves downwards, i.e., away from the fixed contacts 21, 22 so that an electrical connection between the fixed contacts 21, 22 and the contact points 314-317 of the contact bridge 31 is again detached. In the present case, it is assumed that the contact points 314-317 are welded to the fixed contacts 21, 22 due to a thermal load caused by the flowing currents and thus adhere to them and do not immediately detach at the reinforcement arms 25, 26 when the contact bridge 31 is in place.

FIG. 4b) shows the position of the actuation plunger 2 in which the bridge limbs 311, 312 of the contact bridge 31 are in contact with the reinforcement arms 25, 26 of the actuation plunger 2 and then the contact points 314-317 are released from the fixed contacts 21, 22 by a further movement of the actuation plunger 2 in the direction of the fixed contacts 21, 22. Through the further movement of the actuation plunger 2, the force in the direction of movement is transferred to the contact bridge 31 via the reinforcement arms 25, 26. The reinforcement arms 25, 26 additionally strengthen and brace the contact bridge 31 in this direction. In this way, it is possible to apply an increased opening force to the welded contact parts, in contrast to the spring-elastic embodiment of the contact bridge 31 so that it is opened reliably.

In this embodiment, the contact points 314-317 are taken from the fixed contacts 21, 22, i.e., a tensile force acts in the contact bridge 31.

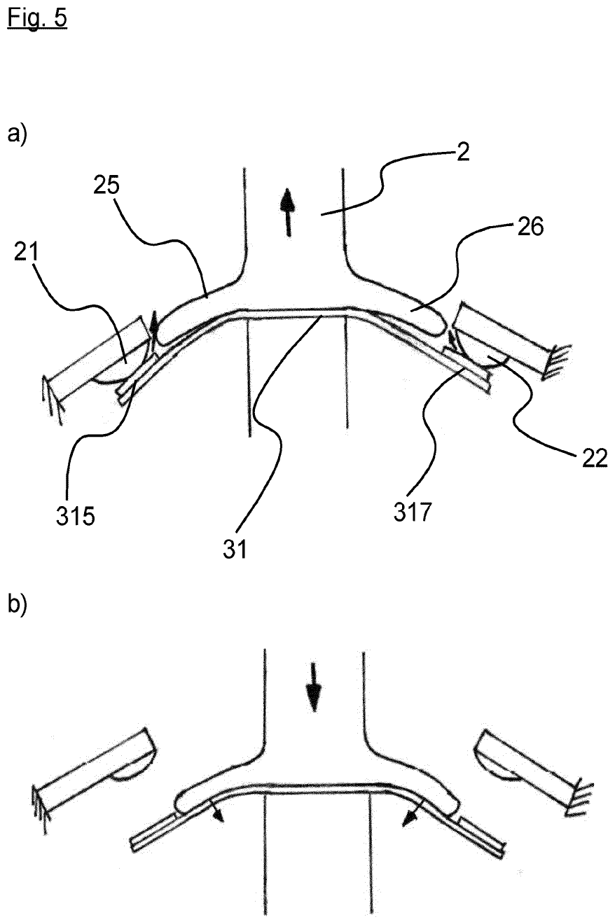

FIGS. 5a) and 5b) show an alternative embodiment of a contact bridge 31 when closing (FIG. 5a)) and opening (FIG. 5b)).

In the exemplary embodiment shown in FIG. 5, the contact bridge 31 has an overall convex embodiment, wherein the reinforcement arms 25, 26 arranged on the actuation plunger 2 are correspondingly inclined downwards. The fixed contacts 21, 22 are also designed to be inclined relative to the horizontal in accordance with an inclination of the contact bridge 31 in the area of contact points 314-317 so that, as shown in FIG. 5a), in the case of contact between contact points 314-317 and fixed contacts 21, 22, self-cleaning does not lead to a displacement of particles as in the embodiment in accordance with FIG. 3 but due to the changed contact situation, this lateral movement between contact points 314-317 and the fixed contacts 21, 22 is a pulling movement directed towards the actuation plunger 2.

In accordance with the changed contact situation, the contact points 314-317 of the fixed contacts 21, 22 as shown in FIG. 5b) are rather pressed when opened, i.e., a compressive force acts in the contact bridge here, which detaches the contact points 314-317 from the fixed contacts 21, 22.

In contrast to the embodiment of the contact points 314-317 shown in FIGS. 2-4, in the embodiment of FIG. 5 the contact points 314-317 are designed as flat contacts and the fixed contacts 21, 22 as cylindrical contacts.

FIG. 6 shows in a more detailed illustration of another embodiment of the contact bridge 31, as it can also be used in an assembly in accordance with FIG. 1.

The contact bridge 31 shown in FIG. 6 is designed as an H-bridge with a first bridge limb 311 and a second bridge limb 312. The bridge limbs 311, 312 are connected to each other in the middle by the transverse bar 313 and are each divided into two bridge limb sections 311a, 311b, 312a, 312b extending from the transverse bar 313.

In the present exemplary embodiment, the transverse bar 313 is centrally arranged so that the bridge limb sections 311a, 311b, 312a, 312b each extend symmetrically from the transverse bar 313 perpendicular to it. As already explained with regard to the embodiment of FIG. 2, the bridge limbs 311, 312 are initially formed with a positive curvature and then extend with a negative curvature so that the contact bridge 31 is concave in a central area and the end areas of the bridge limbs 311, 312 are convex. At the bridge end limbs 311, 312 are the contact points 314-317, wherein, in the present exemplary embodiment, these are designed as contact rivets. Compared to soldered contacts, contact rivets have the advantage that they can be produced in other manufacturing methods. This means that other material combinations are possible. As the name “contact rivets” suggests, the contact points 314-317 are attached to the respective bridge end limb with a rivet.

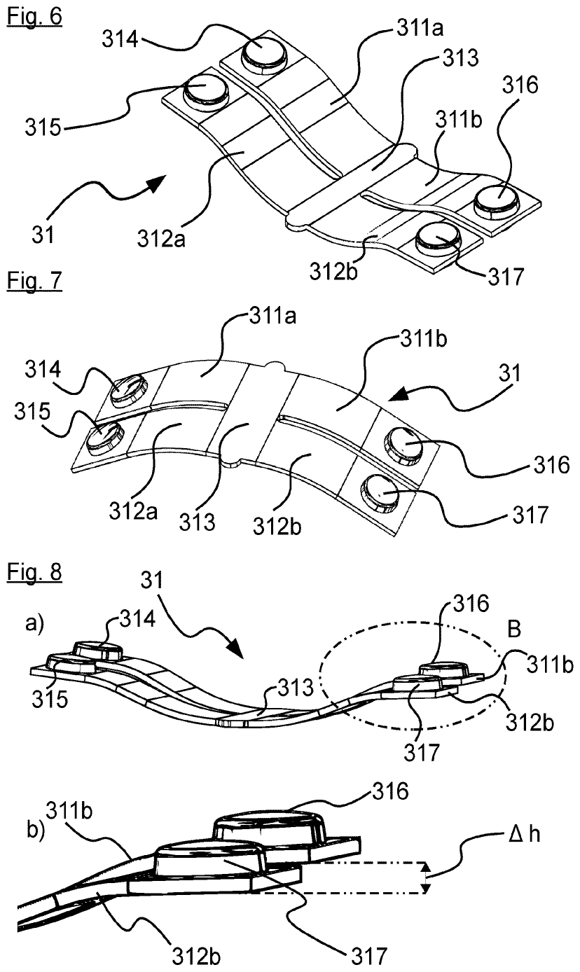

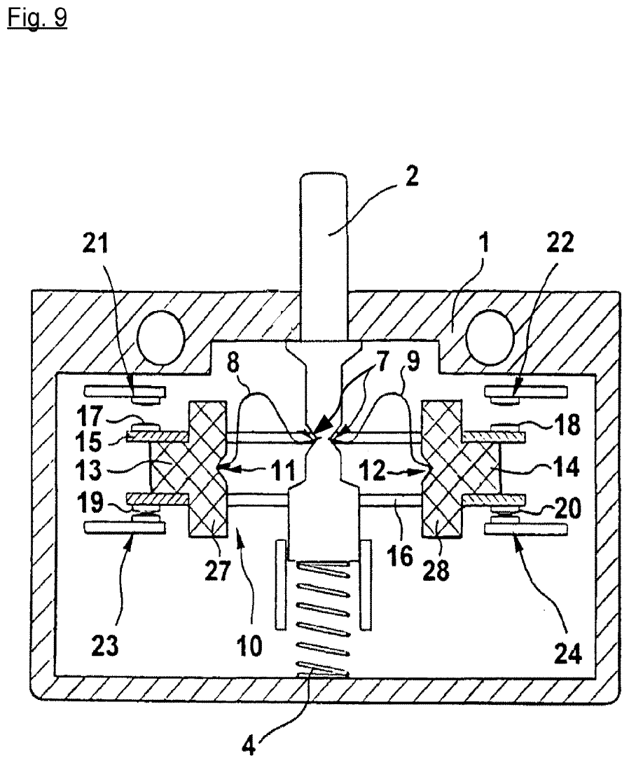

In the present exemplary embodiment, the transverse bar 313 is designed in such a way that it extends linearly between the bridge limbs 311, 312 with a semicircular formation on both sides of the bridge limbs 311, 312. This formation can be used to align and centre the contact bridge 31 within the actuation plunger 2 and thus represents an assembly aid. FIG. 7 shows another exemplary embodiment of a contact bridge 31, wherein the contact bridge 31 shown in FIG. 7 comprises a completely convex progression. The convex course of the contact bridge 31 requires a modified contact geometry and self-cleaning, as shown for example in FIG. 5. In the exemplary embodiment of FIG. 7, the contact points 314-317 are also designed as contact rivets.

FIGS. 8a) and 8b) show a modified embodiment of the contact bridge 31 from FIG. 6.

In contrast to the embodiment of the contact bridge 31 shown in FIG. 6, in which both bridge limbs 311, 312 are each designed to run parallel, the contact bridge 31 is designed in accordance with FIG. 8a) in such a way that one bridge limb is designed to be leading and the other bridge limb trailing behind.

In this context, leading means that the contact point located on the advancing bridge limb contacts the assigned fixed contact in time before the trailing contact point in the case of a movement in the direction of closure and thus establishes an electrically conductive connection in front of it. Conversely, when the switch position is opened, the trailing bridge limb or the contact points assigned to it first lifts off from the respective assigned fixed contact, and the bridge limb advancing in the closing direction is the second to detach the connection.

In the exemplary embodiment shown in FIG. 8, the first bridge limb 311 and thus also the contact points 314, 316 assigned to it is designed to be leading and the second bridge limb 312 with the assigned contact points 315, 317 is designed to be trailing behind. The consequence of this embodiment is that when the contacts are opened, increased current densities and the associated flashovers and the resulting burn-up substantially affect the contact points of the preceding first bridge limb 311. With a suitable choice of material, the advancing bridge limb can, for example, be equipped with contact points made of a material that is more resistant to burn-up, whereas the trailing bridge limb contact points can be provided with a very good conductive, but flashovers with significantly more burn-up and thus a more sensitive material.

FIG. 8b) shows a section enlargement from FIG. 8a), from which it is particularly clear how a leading and a trailing bridge limb can be implemented. In the present exemplary embodiment, the bridge limbs are bent in such a way that the first bridge limb section 311b, which is shown here as an example, projects over the second bridge limb section 312b in the closing direction by one height Ah and is thus ahead in the closing direction.

In an alternative embodiment, the contact rivets used in each case could also have a different height so that the bridge limbs are bent in the same way, but the contact rivets used in each case of the leading contact point have a greater height than the contact rivets of the trailing contact point. Such an embodiment can provide a greater material strength for the contact point in front so that, in addition to a material that is more resistant to burn-up, it also has an additional material strength that can be worn.

### LIST OF REFERENCE NUMBERS

1 housing
2 actuation plunger
3 actuation element
4 compression springs
5 first forced-opening lever
6 second forced-opening lever
8 first snap-action spring
9 second snap-action spring
11, 12 receptacle notch
13, 14 spacer
15 upper contact arm
16 lower contact arm
17 first contact point
18 second contact point
19 third contact point
20 fourth contact point
21 first fixed contact
22 second fixed contact
23 third fixed contact
24 fourth fixed contact
25, 26 reinforcement arm
31 first contact bridge
100 snap-action switch
311 first bridge limb
312 second bridge limb
313 transverse bar

Unless indicated otherwise, identical reference numbers in the figures identify identical components with the same function. The terms drive unit and drive are used interchangeably herein.

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

We claim:

1. A snap-action switch comprising a housing, an actuation plunger with two switch positions with at least one contact bridge for electrically connecting at least one first contact pair in a switch position and with snap-on springs supporting themselves substantially symmetrically and in a pretensioned manner on an actuation element and the actuation plunger, the pitch lines of which can be shifted by the actuation element in such a way, that the actuation plunger can be snapped from a first switch position, in which the actuation plunger is substantially in the resting position, to a second switch position, in which the actuation plunger is substantially in the actuation position, wherein the snap-action switch also comprises a forced-opening assembly with which it is switching at least from the first to the second switch position is imposed on the actuation element when a forced-opening force is exceeded, wherein the at least one contact bridge on one end and on the other hand has at least two respective contact points for electrically parallel contacting of the first contact pair, wherein each of the contact points is designed in such a way as to entirely switch an electrical rated power of the snap-action switch.

2. The snap-action switch according to Patent claim 1, wherein the snap-action switch comprises two contact bridges for electrically connecting at least the first contact pair and at least one second contact pair, wherein the contact points of the second contact bridge are also designed in such a way as to entirely switch an electrical rated power of the snap-action switch.

3. The snap-action switch according to Patent claim 2, wherein, in the first switch position, the first contact pair and in the second switch position the second contact pair is connected.

4. The snap-action switch according to Patent claim 1, wherein the contact bridges are each designed as a single piece.

5. The snap-action switch according to Patent claim 1, wherein the contact bridges are designed in the form of a double H-bridge, each with two bridge limbs on either side of the actuation plunger and at least one transverse bar.

6. The snap-action switch according to Patent claim 1, wherein the contact bridges are designed in such a way that, on both sides of the actuation plunger, one bridge limb formed to be leading, and the other bridge limb is designed to be trailing behind.

7. The snap-action switch according to Patent claim 1, wherein the contact bridges are spring-elastic.

8. The snap-action switch according to Patent claim 1, wherein the contact bridges are designed in such a way and the contact points are arranged in such a way and are arranged relative to the contact pairs that the contacts are self-cleaning.

9. The snap-action switch according to Patent claim 8, wherein the contact points and the contact pairs are formed and arranged relative to each other in such a way that, at least when the contacts are closed, a lateral movement is caused between the contact point and the contact pair.

10. The snap-action switch according to Patent claim 1, wherein the at least two contact bridges are each assigned a reinforcement assembly in the direction of opening.

11. The snap-action switch according to Patent claim 10, wherein the reinforcement assembly is located on the actuation plunger.

12. The snap-action switch according to Patent claims 10, characterized in that the reinforcement assembly is designe as a single piece with the actuation plunger.

13. The snap-action switch according to Patent claim 8, wherein the reinforcement assembly is designed as a formation extending from the actuation plunger in the direction of an extension direction of the contact bridge, in particular, in the form of reinforcement arms.

14. The snap-action switch according to claim 13, wherein the formations support the bend limbs at least to ⅕, preferably at least to ¼, more preferably at least to half, being particularly preferred, to ¾.

15. The snap-action switch according to claim 13, wherein the formations are designed in such a way that the contact bridges are pretensioned.

16. The snap-action switch according to claim 13, wherein the formations are dimensioned in such a way that an opening force of at least 10 N, preferably at least 20 N, and furthermore preferably at least 30 N can be transferred to the bridge limbs.
